(19) United States
(12) Patent Application Publication
(10) Pub. No.: US 2015/0121979 A1
(43) Pub. Date: May 7, 2015

(54) PLANT NUTRIENT SOLUTION HAVING DISSOLVED SILICA AND METHODS OF MAKING THE SAME

(71) Applicant: Bijam Biosciences Private Limited, Hyderabad (IN)

(72) Inventor: Durga Yandapalli Prasad, Yankatala Village (IN)

(21) Appl. No.: 14/530,456

(22) Filed: Oct. 31, 2014

Related U.S. Application Data
(63) Continuation-in-part of application No. 12/939,167, filed on Nov. 3, 2010, now abandoned.

(30) Foreign Application Priority Data
Nov. 4, 2009 (IN) 1025/CHE/2009
Sep. 27, 2010 (IN) 2843/CHE/2010

(51) Int. Cl. C05D 9/00

(52) U.S. Cl. CPC C05D 9/00
USPC 71/62

(57) ABSTRACT

A plant nutrient having silica derived from plant material may include a silica solution. The silica of the silica solution is an agropolymer extract. The silica may be present in the plant nutrient solution in an amount lying in a range of 5 mass percent to 45 mass percent.

### CROSS-REFERENCE TO RELATED APPLICATIONS

This application claims priority to Indian Patent Application Nos. 1025/CHE/2009, filed Nov. 4, 2009, and 2843/CHE/2010, filed Sep. 27, 2010, the disclosures of which are hereby incorporated herein by reference in their entireties. This application is a continuation-in-part of co-pending U.S. patent application Ser. No. 12/939,167, filed Apr. 7, 2014, the disclosure of which is hereby incorporated by reference herein in its entirety.

### FIELD

This disclosure relates to agricultural biotechnology. In particular, this disclosure pertains to efficient plant nutrients and methods of manufacturing the same.

### BACKGROUND

As is known, silica is conventionally produced from white ash obtained by burning rice husk. Silica is also conventionally produced using biopolymers that have heavy metal-binding reactive sites. While the source materials for obtaining silica using conventional methods include high levels of silica content, the amount of silica typically obtained is small, and the amount of silica wasted is significant.

Silica that is produced from white ash obtained by burning rice husk is not water soluble. Moreover, the produced silica is not immediately available for agricultural applications such as for foliar plant nutrition.

### SUMMARY

A need has been identified for plant nutrients having a high silica content. Further, a need has been identified for methods for manufacturing plant nutrients and agropolymer extract having a high biosilica content. Further, there is a need for water soluble and plant available nutritional silica product derived from widely available plant materials. Methods for producing useful agropolymer extract and high silica content plant nutrients from widely available plant materials, such as seed coats, hulls, husks, and seed covers of agricultural crops are desired.

Certain embodiments of the present invention may provide solutions to problems and needs in the art, including those that have not yet been fully identified, appreciated, or solved by agricultural biotechnology. For example, in accordance with some embodiments of the present invention, a plant nutrient having high silica content is provided. In accordance with some embodiments, a plant nutrient may include biosilica derived from agropolymer source material. The agropolymer source material may include plant parts such as seed coats, hulls, husks, or seed covers of plants including agricultural crops such as rice.

Biosilica agropolymer may also be useful as high purity silica for use in powered solar cells. Agropolymer extract having biosilica in accordance with embodiments may have extensive industrial application. For example, agropolymer extract in accordance with some embodiments may be useful for purifying water of aqueous solutions that are polluted or contaminated by metal or ions. Agropolymer extract in accordance with some embodiments may be useful for foliar application, and soil treatment, and may provide water soluble and plant available nutritional silica product. The silica product may be completely water soluble.

Methods of manufacture are provided for producing agropolymer extract having high silica content, or producing biosilica, and for producing plant nutrients having dissolved biosilica extract. In particular, in accordance with some embodiments, methods are provided that relate to plant nutrient manufacturing processes wherein micronized plant material undergoes alkali treatment, acid treatment, or a combination of alkali treatment and acid treatment. The alkali solution used to treat the micronized plant material functions to extract silica such as that derived from rice husk material. The biosilica agropolymer may thus be obtained without, for example, firing the husk.

Further, in accordance with some embodiments, a plant nutrient having silica present in a high amount, for example, 5 mass percent to 20 mass percent may be obtained. In accordance with some embodiments, a biosilica agropolymer rich in silica content may be formed from rice husk or other plant materials. For example, a biosilica agropolymer in accordance with some embodiments may include silica in an amount lying in a range of 10 mass percent to 45 mass percent.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 shows comparative FTIR analysis of plant nutrient derived from rice husk.

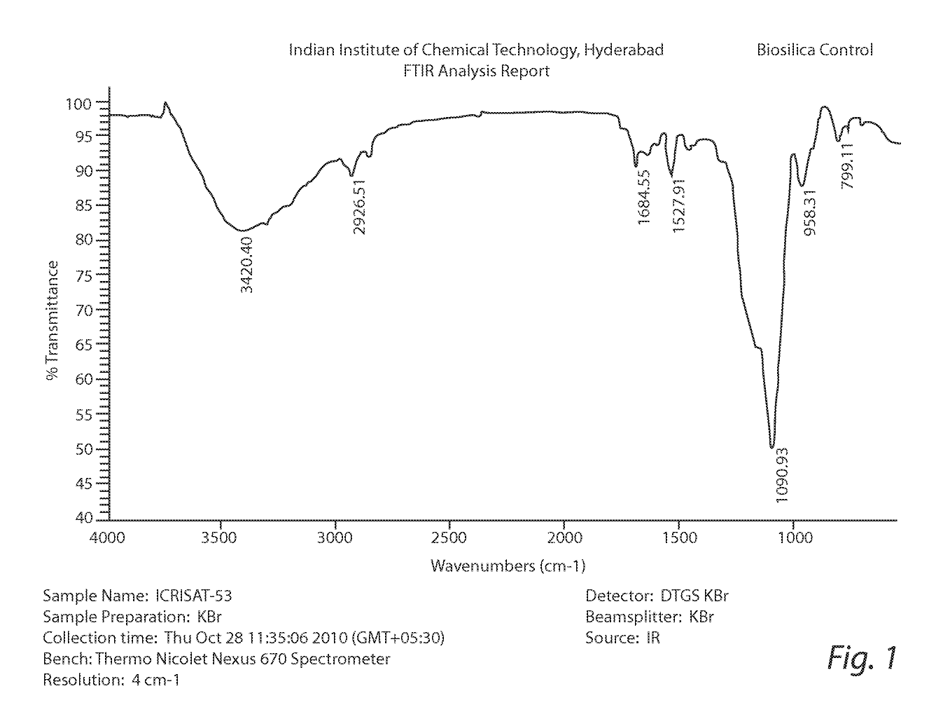

FIG. 2 shows comparative FTIR analysis of plant nutrient derived from rice husk.

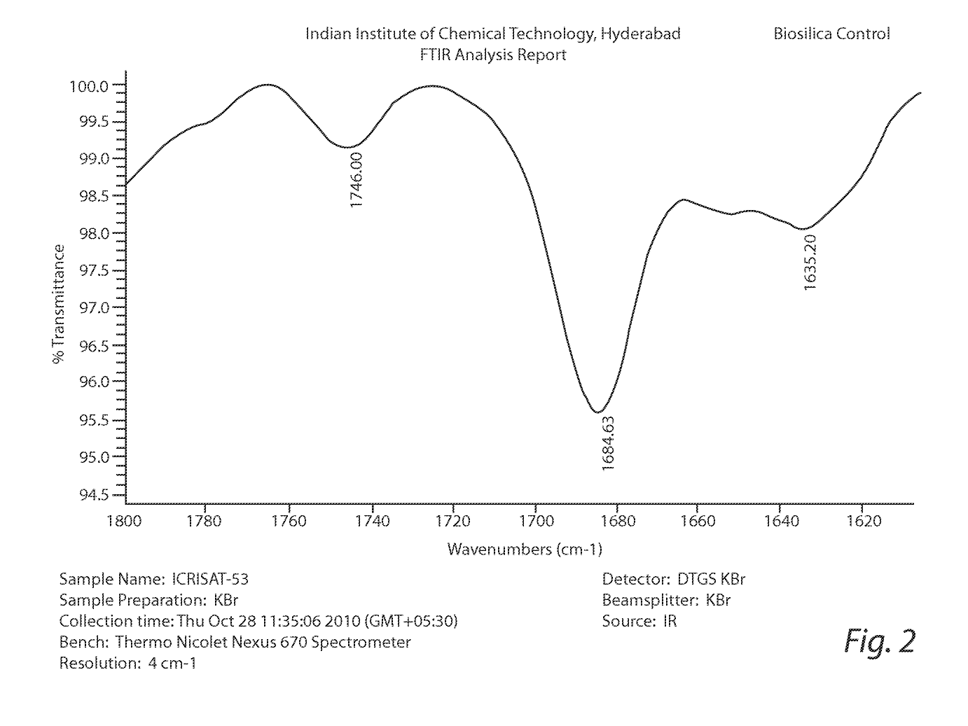

### DETAILED DESCRIPTION

Some embodiments of the present invention pertain to an agropolymer extract having high silica content, or a biosilica extract, and plant nutrients having a high silica content. The agropolymer extract may be obtained from processing agropolymer source material such as rice husk, and other plant materials. Some embodiments of the present invention pertain to methods of producing biosilica agropolymer having a high silica content by processing plant material such as rice without firing the husk of the rice.

Some embodiments of the present invention may include uses of biosilica agropolymer and high silica-content plant nutrients of embodiments, including foliar treatment and seed applications. Further, biosilica agropolymers in accordance with some embodiments may form a binding material with resin. As such, some embodiments of the invention may include use as a binding material for ground filling to prevent ground water and soil pollution from industrial or toxic metal pollutants.

A silica content of a plant nutrient in accordance with some embodiments may be an amount lying in a range of 5 mass percent to 25 mass percent. In some embodiments, the silica content of a plant nutrient may be an amount lying in the range of 10 mass percent to 24 mass percent. In further embodiments, the silica content of a plant nutrient may be an amount lying in a range of 5 mass percent to 20 mass percent.

In some embodiments, a plant nutrient may include a biosilica extract dissolved in alkali solution. In some embodiments, a plant nutrient solution may be treated with metal silicate for plant seed or seedling treatment. The metal silicate may be any suitable metal silicate. For example, the metal silicate may be a metal silicate selected from the group comprising copper, zinc, iron, manganese, molybdenum, and mixtures thereof.

Methods of manufacturing a plant nutrient in accordance with some embodiments may include obtaining agropolymer from a rice husk, for example. Alternatively, an agropolymer in accordance with embodiments may be derived from materials other than rice in accordance with methods of embodiments.

Methods for obtaining a plant nutrient or agropolymer extract from agropolymer source material is described with reference to rice husk by way of example. Methods in accordance with some embodiments may include the steps of:

(a) mixing rice husk and alkali solution in the proportion of 1:3 mass concentration to 1:20 w/v along with water, and heating the mixture for obtaining an agropolymer solution of the same, and residue or the left-over of the rice husk having a low silica content below 5 mass percent;

(b) Obtaining silica, for example, 65% precipitate, by acidifying the agropolymer solution and residue mixture obtained by step (a), and filtering the acidified mixture and

(c) Dissolving the biosilica of step (b) in alkali silicate. The alkali silicate may be present in an amount of 10 w/v and 20 w/v. The obtained biosilica may be used alone or with other plant nutrients.

In some embodiments, the alkali solution may be configured for foliar nutrition. For example, a dosage of 1 ml/L for foliar application may be effective for plant resistance and yield enhancement. In some embodiments, the alkali solution may have a silicate concentration lying in a range of 5 mass percent to 25 mass percent.

In methods in accordance with some embodiments, the acid treatment conducted in step (b) may include acidifying the mixture obtained by step (a) until the mixture has a pH of 2. The mixture may be acidified with acids from the group comprising HCl and H₂SO⁴, for example. H₂SO⁴ present in an amount in a range of a mass concentration of 5% to a mass concentration 25% may be used to obtain agropolymer extract from rice husk, leaving husk residue having a silica content in an amount lying in a range of less than 5 mass percent.

In some methods in accordance with embodiments, agropolymer obtained by acidifying and filtering at step (b) may be further treated with metal silicate. The agropolymer obtained at step (b) may be treated at step (c) with metal silicate to obtain agropolymer embedded with a high amount of silica. The silica may be present, for example, in an amount lying in a range of 5 mass percent to 45 mass percent.

The agropolymer source material used in methods in accordance with some embodiments may include tannins, humic acid, whole cell biomass, chitin and chitin derivatives, metallothioneins, microbial polysaccharides, melannins, polyphenolic biopigments, bacterial cell wall polymers, microbially produced chelating agents (siderophores), and the like. Such materials may be costly, and may be available only in limited supply. Accordingly, in some embodiments, methods may include obtaining biosilica from enhanced rice agropolymer production processes. Such agropolymer source materials may be micronized, and used in methods as disclosed.

In some methods in accordance with embodiments, alkali treatment of agropolymer material such as rice husk may be enhanced with the addition of sodium hydroxide, potassium hydroxide, sodium carbonate, or any suitable alkali solution, or adding hydrogen peroxide to the reaction mixture. It was found, for example, that treatment with hydrogen peroxide in a mass concentration of 5% to a mass concentration of 30%, along with alkali treatment in an amount of 1 mass percent to 10 mass percent resulted in rice agropolymer having desirably high silica content. It was found that rice husks treated with a higher concentration of alkali, an amount of 11 mass percent to 20 mass percent, for example, provided a solution from which a desirably high amount of silica was removed from the agropolymer source material or rice husk. The resulting solution may be acidified with acids such as HCl to precipitate biosilica.

The following actual examples are illustrative of the features and advantages of plant nutrient materials and method in accordance with some embodiments.

### Example 1

In this example, 1.0 Kg rice husk was mixed in solution with 20-30% KOH and about 5 to about 10 liters water while heating. The solution was heated, regularly stirred, and agitated by shaking for six hours. The resulting solution was subsequently filtered to obtain the extract of rice husk in solution, and residue left over of the rice husk extract. The extract of rice husk contains silica in an amount of 5 mass percent to 20 mass percent. The extract was acidified with HCl or H₂SO⁴ to achieve a pH below 2, and to obtain precipitate rich in silica. A dry weight amount of silica in an amount of 10 mass percent to 20 mass percent was obtained. Silica derived from the rice husk was further dissolved in various concentrations with alkali, and was used for foliar nutrition. It was found that a foliar spray containing a concentration of 2% silica enhanced rice yields up to 15%.

### Example 2

It was found that when the extract of rice husk produced as shown in Example 1 was further dissolved in various concentrations with alkali, its use for foliar nutrition was enhanced. For example, at various concentrations with other nutrients such as urea, and at a concentration of 2% to 3%, a foliar spray in accordance with some embodiments enhanced yields up to 25%, in the rice. Crop yield enhancement was shown for other crop varieties, as shown in Table 1.

TABLE 1

| | Lint Yield | |
|---|---|---|
| Treatment on cotton | (1picking) (kg/acre) | % in yield increment |
| FP + Bio silica applied | 138 | 151 |
| Farmer practice | 55 | |
| Treatment on chilli | Yield (Ton/acre) | % in yield increment |
| FP + Bio silica applied | 8.626 | 63 |
| Farmer practice | 5.454 | |
| Treatment on maize | Yield (Ton/acre) | % in yield increment |
| FP + Bio silica applied | 1.56 | 66 |
| Farmer practice | 0.94 | |

Table 1 shows that foliar treatment using agropoylmer and methods in accordance with some embodiments may enable percent crop yield increments of 66% for maize, 63% for chilli, and 151% for cotton.

It will be readily understood that the components of various embodiments of the present invention, as generally described and illustrated in the figures herein. Thus, the detailed description of the embodiments of the plant nutrients, agropolymers, and methods of the present invention is not intended to limit the scope of the invention as claimed, but is merely representative of selected embodiments of the invention.

The features or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

The modifiers “about” and “approximately” used in connection with a quantity are inclusive of the stated value and have the meaning dictated by the context. For example, it includes at least the degree of error associated with the measurement of the particular quantity. When used with a specific value, they also disclose that value.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order as appropriate. Therefore, although the invention has been described based upon these preferred embodiments, it would be apparent to those of skill in the art that certain modifications, variations, and alternatives would be apparent, while remaining within the spirit and scope of the invention. In order to determine the metes and bounds of the invention, therefore, reference should be made to the appended claims.

What is claimed is:

1. A plant nutrient having silica derived from plant material, comprising:
a silica solution, the silica solution having silica, the silica being present in an amount lying in a range of 5 mass percent to 45 mass percent, 5 mass percent to 25 mass percent, 5 mass percent to 20 mass percent, 10 mass percent to 20 mass percent, or 10 mass percent to 45 mass percent.

2. The plant nutrient of claim 1, wherein the silica is present in an amount lying in a range of 5 mass percent to 20 mass percent.

3. The plant nutrient of claim 1, wherein the silica is present in an amount lying in a range of 10 mass percent to 45 mass percent.

4. A method of preparing a plant nutrient obtained from plant material, comprising:
mixing an agropolymer source material and an alkali solution in a proportion lying in a range of 1:3 mass concentration to 1:20 mass concentration heating the mixture of agropolymer source material and the alkali solution to obtain an agropolymer source material residue in a mixture of the agropolymer source material and alkali solution, and the residue, the residue having a silica content in an amount less than 5 mass percent;
acidifying the mixture of the heated agropolymer source material in alkali solution and the residue to precipitate biosilica; and
filtering the biosilica precipitate from the acidified mixture of the solution agropolymer source material and alkali solution and the residue to yield filtered biosilica precipitate.

5. The method of claim 4, comprising:
dissolving the biosilica precipitate in alkali silicate solution to form a concentrated biosilica solution.

6. The method of claim 5, wherein the alkali silicate comprises potassium silicate, the potassium silicate being present in an amount lying in a range of 10 mass percent to 20 mass percent.

7. The method of claim 5, wherein the concentrated biosilica solution is useful as a foliar nutrient.

8. The method of claim 5, wherein the concentrated biosilica solution is present in an amount of 5 mass percent to 25 mass percent.

9. The method of claim 4, the acidifying further comprising:
adding acid until the mixture has a pH of 2, wherein the acid is selected from the group comprising HCl and H₂SO⁴.

10. The method of claim 11, the acidifying further comprising:
adding an acid solution, the acid solution comprising H₂SO⁴ in a concentration lying in a range of 5 percent to 25 percent.

11. The method of claim 4, comprising:
adding metal silicate in an amount of 5 mass percent to 45 mass percent.

12. The method of claim 4, wherein the agropolymer source material further comprises rice husk.
